(19) United States
(12) Patent Application Publication
(10) Pub. No.: US 2013/0209857 A1
(43) Pub. Date: Aug. 15, 2013

(54) BATTERY TRAY DESIGN

(71) Applicants: Leonid C. Lev, West Bloomfield, MI (US); Mark A. Smith, Huntington Woods, MI (US)

(72) Inventors: Leonid C. Lev, West Bloomfield, MI (US); Mark A. Smith, Huntington Woods, MI (US)

(73) Assignee: GM GLOBAL TECHNOLOGY OPERATIONS LLC, Detroit, MI (US)

(21) Appl. No.: 13/396,779

(22) Filed: Feb. 15, 2012

(51) Int. Cl. H01M 10/50; B65B 5/06; B65B 63/00; H01M 2/10

(52) U.S. Cl. 429/120; 429/159; 53/436; 53/440; 53/443

(57) ABSTRACT

A battery pack includes a plurality of battery cells configured to generate an electrical current from an electrochemical reaction and a battery tray. The battery tray includes a channel formed from a plurality of walls. The channel is configured to receive at least a portion of the battery cells therein and permits at least an axial translation of the battery cells in respect of a longitudinal axis of the battery tray to accommodate an expansion and a contraction of the battery cells during an operation of the battery pack.

### FIELD OF THE INVENTION

The present disclosure relates to a battery pack and more particularly to a tray for a battery pack.

### BACKGROUND OF THE INVENTION

Batteries have been proposed as a clean, efficient and environmentally responsible power source for electric vehicles and various other applications. One type of battery is known as a lithium-ion battery. The lithium-ion battery is rechargeable and can be formed into a wide variety of shapes and sizes so as to efficiently fill available space in electric vehicles. For example, the battery may be prismatic in shape to facilitate a stacking of individual battery cells. A plurality of the individual battery cells can be provided in a battery pack to provide an amount of power sufficient to operate electric vehicles.

Typical prismatic battery cells have a pair of plastic coated metal layers fused around a periphery of the battery cell in order to seal the battery cell components. The sealing of the battery cells generally begins with providing one of the plastic coated metal layers with a cavity, sometimes called a “butter dish” shape. The battery cell components are disposed inside the cavity of the plastic coated metal layer. The other of the plastic coated metal layers is then placed on top of the battery cell components and fused at the periphery to the one of the plastic coated metal layers with the cavity, for example, by heat sealing around the edges. The battery cell for incorporation into the battery pack is thereby provided.

Battery cells such as lithium-ion battery cells are known to generate heat during operation and as a result of a charge cycle when recharging. When overheated or otherwise exposed to high-temperature environments, undesirable effects can impact the operation of the lithium-ion battery cells. Accordingly, a cooling system is typically employed with the lithium-ion battery pack to militate against the undesirable overheating conditions. The cooling system may include cooling plates or fins sandwiched between the individual battery cells within the battery pack. The cooling system may have channels through which a coolant flows in a heat transfer relationship with the battery cells.

The battery cells and the cooling system are often disposed within repeating frame assemblies that form repeating units of the battery pack. Module end frames and the repeating units are then stacked and compressed to form the assembled battery pack. It is generally necessary to employ the use of multiple seals (e.g. end and perimeter seals) within the assembled battery pack in order to form fluid-tight manifolds for delivery of coolant to the cooling system. The module end frames and the repeating frame assemblies cooperate with compression rods to hold the repeating units under compression. The compression rods are disposed through apertures formed in the module end frames and the repeating frame assemblies. The module end frames and the repeating frame assemblies are often formed from plastic in order to minimize a mass of the assembled battery pack. However, the module end frames and the repeating frame assemblies require complex fabrication, precise assembly alignment, and the plastic materials employed cannot generally withstand the loads required for assembly and operation of the battery pack.

Accordingly, there is a continuing need for a battery tray for the battery pack which reduces the number of components required for assembly of the battery pack, thereby minimizing a cost and a mass of the battery pack while maintaining a structural integrity thereof.

### SUMMARY OF THE INVENTION

In concordance and agreement with the present disclosure, a battery tray for the battery pack which reduces the number of components required for assembly of the battery pack, thereby minimizing a cost and a mass of the battery pack while maintaining a structural integrity thereof, is surprisingly discovered.

In a first embodiment, the battery pack, comprises: a plurality of battery cells configured to generate an electrical current from an electrochemical reaction; and a battery tray including a channel configured to receive at least a portion of the battery cells therein, wherein the channel permits at least an axial translation of the battery cells in respect of a longitudinal axis of the battery tray.

In another embodiment, the battery pack, comprises: a plurality of battery cell assemblies, each of the battery cell assemblies including a battery cell and a cooling element, wherein the battery cell includes a main body configured to generate power from an electrochemical reaction with the main body, the main body having a pair of electrical tabs extending outwardly therefrom, and wherein the cooling element is disposed adjacent the main body of the battery cell, the cooling element including at least one cooling passage in heat exchange relationship with the main body of the battery cell and configured to transfer heat generated during the electrochemical reaction away from the main body; a battery tray including a plurality of first walls extending upwardly from a bottom wall, wherein inner surfaces of the walls form a channel configured to receive at least a portion of the battery cell assemblies therein, wherein the channel permits at least an axial translation of the battery cell assemblies in respect of a longitudinal axis of the battery tray; and at least one urging mechanism for applying a compressive load to the battery cell assemblies in a first axial direction substantially parallel to the longitudinal axis of the battery tray.

The present invention also relates to a method for manufacturing the battery pack.

The method comprises the steps of: providing a plurality of battery cells configured to generate an electrical current from an electrochemical reaction; providing a battery tray including a channel configured to permit at least an axial translation of the battery cells in respect of a longitudinal axis of the battery tray; and disposing the battery cells at least partially within the channel of the battery tray.

### DRAWINGS

The above, as well as other advantages of the present disclosure, will become readily apparent to those skilled in the art from the following detailed description, particularly when considered in the light of the drawings described herein.

FIG. 1 is a partially exploded perspective view of a battery pack including a plurality of battery cell assemblies at least partially disposed in a battery tray of the battery pack according to an embodiment of the present invention; and

FIG. 2 is an exploded perspective view of one of the battery cell assemblies illustrated within circled area 2 of in FIG. 1.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner.

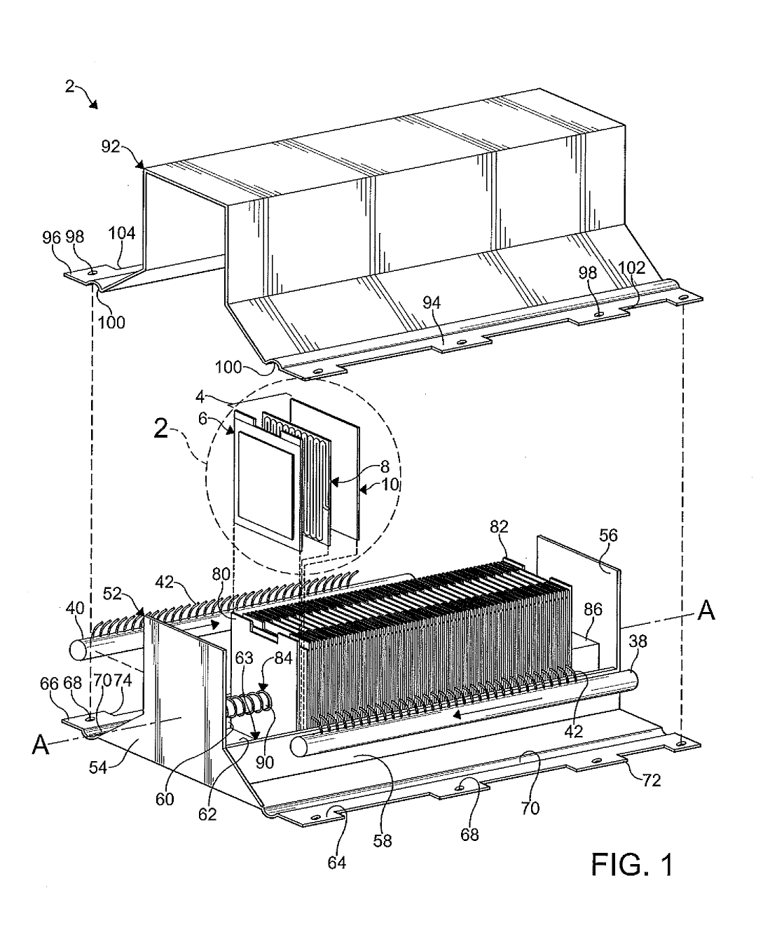

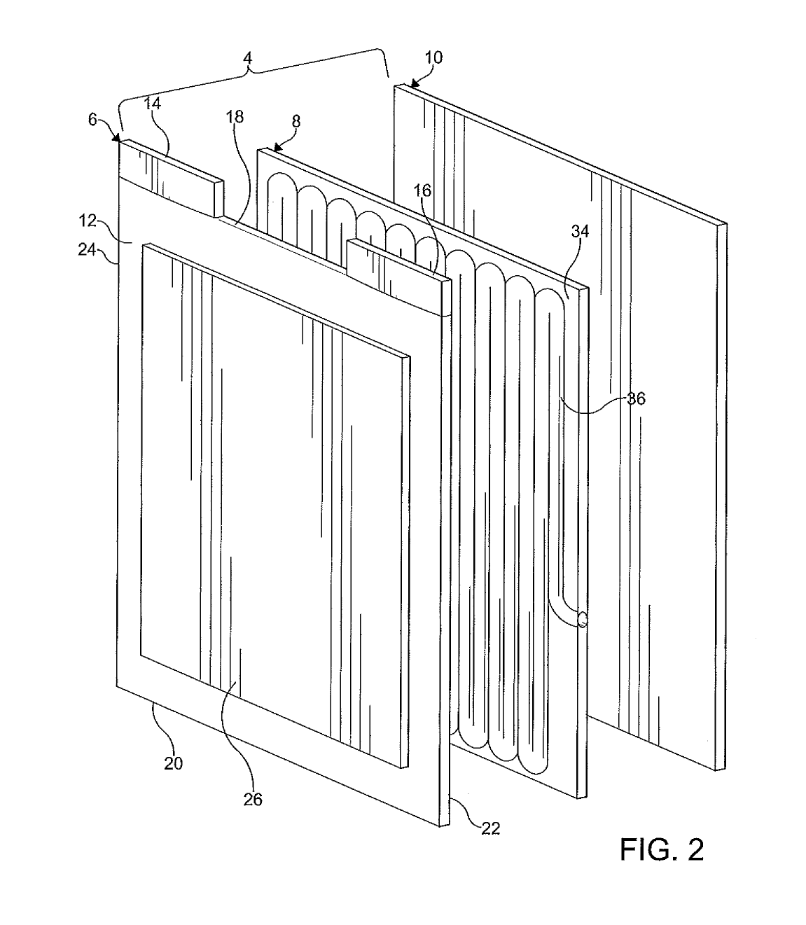

FIG. 1 shows an exemplary battery pack 2 according to the present disclosure. The battery pack 2 shown includes a plurality of repeating battery cell assemblies 4 suitable for powering an electric vehicle. It is understood that the back pack 2 can be used in other applications as desired. Each of the battery cell assemblies 4 shown includes a battery cell 6, a cooling element 8, and a compliant or deformable spacer 10. It is understood that the battery pack 2 can be formed without the cooling elements 8 and the spacers 10 if desired. As more clearly shown in FIG. 2, each of the battery cells 6 of the battery cell assembly 2 includes a main body 12 and a pair of electrical tabs 14, 16. The main body 12 of the battery cell 6 is configured to generate power from an electrochemical reaction within the main body 12. The main body 12 may include, for example, electrode coated current collector plates, liquid electrolytes, and separator films as are generally known in the art. The electrical tabs 14, 16 are suitable for placing the battery cell 6 in electrical communication with additional battery cells 6 to form the battery pack 2. For example, the battery cells 6 can be electrically connected by a conductive mechanical means such as crimping, soldering, or ultrasonic welding. Accordingly, an individual battery cell 6 within the battery pack 2 can be easily removed and replaced. Other suitable processes to electrically connect and form the battery pack 2 can be used if desired.

As a further example, the battery cells 6 may be lithium ion (Li-ion) battery cells. It should be appreciated that other types of the battery cells 6, employing at least one of a different structure and a different electrochemistry, may also be used within the scope of the present invention. The main body 12 of the battery cell 6 may be prismatic, i.e., have substantially parallel sides and suitable for stacking to form the battery pack 2. The main body 12 of a prismatic battery cell 6 includes a first end 18 and a second end 20, a first side 22 and a second side 24, and a first major surface 26 and a second major surface (not shown). The electrical tabs 14, 16 extend outwardly from the first end 18 of the main body 12.

A temperature of the battery cell 6 is maintained in a desired range by the cooling element 8. As shown, the cooling element 8 is disposed between the battery cell 6 and the spacer 10 under compression and in heat transfer communication with the battery cell 6. In certain embodiments, the cooling element 8 abuts the second major surface of the battery cell 6.

The cooling element 8 may include a pair of spaced apart layers 34 defining a plurality of cooling passages 36 of the cooling element 8. The cooling passages 36 are in a heat exchange relationship with the main body 12 of the battery cell 6. The cooling passages 36 are configured to transfer heat generated during the electrochemical reaction away from the main body 12. In the illustrated embodiment of FIG. 1, the cooling passages 36 are in fluid communication with a supply fluid manifold 38 and an exhaust fluid manifold 40 via a substantially flexible conduit 42 for circulation of a fluid (e.g. air or coolant) through the cooling passages 36. It is understood that the fluid manifolds 38, 40 can be in fluid communication with a cooling system of the vehicle if desired. The flexible conduits 42 are configured to permit an axial translation of the cooling elements 8 with respect of a longitudinal axis A of the battery pack 2 to accommodate an expansion and a contraction of the battery cells 6 during operation of the battery pack 2.

In the embodiment shown, the cooling passages 36 of the cooling element 30 extend from the first side 22 of the main body 12 adjacent the supply fluid manifold 38 to the second side 24 of the main body 12 adjacent the exhaust fluid manifold 40. The cooling passages 36 are substantially serpentine shaped, as shown, although other shapes may also be employed within the scope of the disclosure. Other means for transferring heat from the main body 12 of the battery cell 6 may also be employed within the scope of the present disclosure. For example, the battery cell 6 may be formed with integrated cooling passages which permit a flow of the fluid through the battery cell 6.

As shown, the cooling element 8 is sandwiched between the battery cell 6 and the spacer 10. In certain embodiments, the spacer 10 of one of the battery cell assemblies 4 abuts the first major surface 26 of the battery cell 6 of an adjacent one of the battery cell assemblies 4. The spacer 10 may be conductive or nonconductive, as desired. As an illustrative example, the spacer 10 may be formed from nonconductive foam that deforms with compression of the battery cells 6. The spacer 10 militates against an undesirable movement of the battery cells 6 during operation of the battery pack 2. Other compliant or deformable materials may also be employed for the spacer 10, as desired.

The battery cell assemblies 4 are arranged and at least partially disposed within a battery tray 52 in a stacked relation to form the battery pack 2. In the illustrated embodiment, the battery tray 52 includes end walls 54, 56 axially spaced apart in a direction substantially parallel to the longitudinal axis A of the battery pack 2 and side walls 58, 60 laterally spaced apart in a direction substantially perpendicular to the longitudinal axis A of the battery pack 2. The walls 54, 56, 58, 60 extend upwardly from a common bottom wall 62. It is understood that the walls 54, 56, 58, 60, 62 can be separately formed or integrally formed as a unitary structure if desired. It is further understood that the battery tray 52 can be formed from any suitable material (i.e. stainless steel) using any suitable forming process or processes (e.g. stamping and welding) as desired. As shown, the fluid manifolds 38, 40 are disposed adjacent outer surfaces of the respective side walls 58, 60.

In certain embodiments, inner surfaces of the walls 54, 56, 58, 60, 62 form a generally rectangular channel 63 having a generally U-shaped cross-section. However, it is understood that the channel 63 can have other suitable shapes for receiving at least a portion of the battery cell assemblies 4 therein. As shown, the inner surfaces of the walls 58, 60 substantially conform to and abut the respective sides 22, 24 of the battery cells 6. The inner surfaces of the walls 58, 60, however, can have any shape as desired suitable to militate against lateral movement of the battery cells 6 within the channel 63 of the battery tray 52. The channel 63 of the battery tray 52 is provided to align the batteries cell assemblies 4, as well as increase a rigidity and structural integrity of the battery pack 2. The channel 63 also permits an axial translation of the battery cell assemblies 4 in respect of the longitudinal axis A of the battery pack 2 to accommodate the expansion and the contraction of the battery cells 6 during operation of the battery pack 2.

As shown in FIG. 1, the battery tray 52 may further include an opposing pair of laterally outwardly extending flanges 64, 66. The flanges 64, 66 can be separately or integrally formed with the bottom wall 62 or the side walls 58, 60 adjacent one of a lower edge or an upper edge thereof. In the illustrated embodiment, each of the flanges 64, 66 includes a plurality of apertures 68 and a groove 70 for receiving a sealing member (not shown) therein. Outer edges 72, 74 of the respective flanges 64, 66 may be planar or irregular, as shown, for a mounting of the battery pack 2 in the vehicle.

The battery cell assemblies 4 are arranged within the channel 63 between opposing end plates 80, 82 of the battery tray 52. Although the end plates 80, 82 shown are generally rectangular in shape, it is understood that the end plates 80, 82 can have other shapes suitable for abutment with the battery cell assemblies 4. Additional spacers 10 may be disposed between the end plates 80, 82 and the battery cell assemblies 4 if desired. An urging mechanism 84 is configured to apply and maintain a compressive force upon the battery cell assemblies 4. As a non-limiting example, the urging mechanism 84 is configured to maintain a compressive force of about 900N applied to the battery cell assemblies 4. In certain embodiments, the spacers 10 of the battery cell assemblies 4 are configured to substantially uniformly distribute the compressive force applied upon the battery cell assemblies 4. The urging mechanism 84 is further configured to permit the axial translation of the battery cell assemblies 4 with respect of the longitudinal axis A of the battery pack 2 to accommodate the expansion and the contraction of the battery cells 6 during operation of the battery pack 2.

In the illustrated embodiment, the urging mechanism 84 is, disposed between and coupled to the end plate 80 and the end wall 54. It is understood, however, that the urging mechanism 84 or an additional urging mechanism (not shown) can be disposed between and coupled to the end plate 82 and the end wall 56 if desired. It is further contemplated that a support member 86 can be disposed between one of the end plates 80, 82 and the respective end wall 54, 56 if desired. As a non-limiting example, the urging mechanism 84 is a spring 88 having a desired spring rate. It is understood that the urging mechanism 84 can include an extensible and contractible plunger 90 to provide stability to the spring 88 if desired. Other means or mechanisms suitable for applying and maintaining the compressive force upon the battery cell assemblies 4 and for accommodating the expansion of the battery cells 6 can be employed as desired.

The battery pack 2 may further include a cover 92 for substantially enclosing the battery cell assemblies 4. As shown, the cover 92 is configured to cooperate with the end walls 54, 56 of the battery tray 52 without interfering with the fluid manifolds 38, 40. The cover 92 may further include an opposing pair of laterally outwardly extending flanges 94, 96 configured to cooperate with corresponding flanges 74, 76 of the battery tray 52. In the illustrated embodiment, each of the flanges 94, 96 of the cover 92 includes a plurality of apertures 98 and a groove 100 for receiving the sealing member therein. Outer edges 102, 104 of the respective flanges 94, 96 may be planar or irregular, as shown, for the mounting of the battery pack 2 in the vehicle. The cover 92 can be coupled to the battery tray 52 by any method as desired such as fastening, welding, soldering, adhesive, and the like, for example.

To manufacture the battery pack 2, the battery cell assemblies 4 are at least partially disposed within the channel 63 of the battery tray 52 in stacked relation. Once the battery cell assemblies 4 are arranged within the channel 63, the urging mechanism 84 applies a compressive load upon the battery cell assemblies 4 to form the battery pack 2. A cover 92 may then be coupled to the battery tray 52 to at least partially enclose the battery cell assemblies 4 to militate against exposure to environmental elements and conditions. During operation of the battery pack 2, prismatic battery cells 6 can exhibit changes in thickness during a charging and a discharging thereof and over a lifetime of the battery cells 6. In certain instances, each battery cell 6 can swell or contract, causing a change in one or more dimensions of the battery cells 6 and the battery cell assemblies 4. When the change in dimensions of the battery cells 6 and the battery cell assemblies 4 occurs, the channel 63 of the battery tray 52 and the urging mechanism 84 permit axial translation of the battery cells 6 and the battery cell assemblies 4 in respect of the longitudinal axis A of the battery tray 52. Thus, the compressive load applied to the battery cells 6 and the battery cell assemblies 4 is maintained in the desired range. It is also contemplated in the present disclosure that the battery tray 52 may also be configured to permit lateral translation of the battery cells 6 and the battery cell assemblies 4 in respect of the longitudinal axis A of the battery tray 52 during the charging and the discharging of the battery cells 6 and the battery cell assemblies 4. Further, when the battery cell assemblies 4 include the cooling elements 8, the flexible conduits 42 permit axial translation of the cooling elements 8 along with the battery cells 6 in respect of the longitudinal axis A of the battery tray 52 during operation of the battery pack 2.

Advantageously, the battery pack 2 includes the battery tray 52 of the present disclosure. The use of the battery tray 52 minimizes a complexity of assembling the battery pack 2 since module end frames, repeating frame assemblies, compression limiters, seals, or an interconnect board to electrically connect the battery cell assemblies 4 are not required. Complex fabrication of the module end frames and the repeating frame assemblies is no longer needed. In addition, the employment of the battery tray 52 beneficially permits the manufacturer to directly monitor and manage individual battery cells 6, as well as remove and replace an individual battery cell 6 if desired. The ability to remove and replace an individual battery cell 6 from the battery pack 2 avoids destructive disassembly and shut down of the entire battery pack 2.

Structural integrity of the battery pack 2 is also greatly improved with the use of the unitary battery tray 52 instead of the significant number of module end frames and repeating frame assemblies. Elimination of the module end frames and repeating frame assemblies results in a mass reduction of the battery pack 2. The battery tray 52 of the present disclosure also allows for at least an axial translation of the battery cell assemblies 4 to accommodate an expansion and a contraction of the battery cell assemblies 4 during an operation of the battery pack 2. The battery tray 52 may also allow for a lateral translation of the battery cell assemblies 4 to accommodate the expansion and the contraction of the battery cell assemblies 4 during the operation of the battery pack 2.

While certain representative embodiments and details have been shown for purposes of illustrating the invention, it will be apparent to those skilled in the art that various changes may be made without departing from the scope of the disclosure, which is further described in the following appended claims.

What is claimed is:

1. A battery pack, comprising:
a plurality of battery cells configured to generate an electrical current from an electrochemical reaction; and
a battery tray including a channel configured to receive at least a portion of the battery cells therein, wherein the channel permits at least an axial translation of the battery cells in respect of a longitudinal axis of the battery tray.

2. The battery pack of claim 1, wherein the battery tray is a unitary structure to provide structural integrity to the battery pack.

3. The battery pack of claim 1, wherein the channel has a substantially U-shaped cross-section.

4. The battery pack of claim 1, further comprising a plurality of cooling elements, wherein each of the cooling elements is disposed between adjacent battery cells.

5. The battery pack of claim 4, wherein each of the cooling elements is in fluid communication with a supply fluid manifold and an exhaust fluid manifold through a flexible conduit.

6. The battery pack of claim 1, further comprising at least one urging mechanism for applying a compressive load to the battery cells in a first axial direction substantially parallel to the longitudinal axis of the battery tray.

7. The battery pack of claim 6, wherein the compressive load applied to the battery cells is about 900N.

8. The battery pack of claim 6, wherein the at least one urging mechanism includes a spring.

9. The battery pack of claim 6, wherein the at least one urging mechanism permits axial translation of the battery cells in respect of the longitudinal axis of the battery tray.

10. A battery pack, comprising:
a plurality of battery cell assemblies, each of the battery cell assemblies including a battery cell and a cooling element, wherein the battery cell includes a main body configured to generate power from an electrochemical reaction with the main body, the main body having a pair of electrical tabs extending outwardly therefrom, and wherein the cooling element is disposed adjacent the main body of the battery cell, the cooling element including at least one cooling passage in heat exchange relationship with the main body of the battery cell and configured to transfer heat generated during the electrochemical reaction away from the main body;
a battery tray including a plurality of first walls extending upwardly from a bottom wall, wherein inner surfaces of the walls form a channel configured to receive at least a portion of the battery cell assemblies therein, wherein the channel permits at least an axial translation of the battery cell assemblies in respect of a longitudinal axis of the battery tray; and
at least one urging mechanism for applying a compressive load to the battery cell assemblies in a first axial direction substantially parallel to the longitudinal axis of the battery tray.

11. The battery pack of claim 10, wherein each of the battery cell assemblies further includes a spacer, the spacer of one of the battery cell assemblies is disposed adjacent the main body of an adjacent one of the battery cell assemblies.

12. The battery pack of claim 10, wherein each of the electrical tabs of one of the battery cells is electrically connected to the electrical tabs of adjacent battery cells to permit at least one of removal and replacement of the one of the battery cells.

13. The battery pack of claim 10, wherein the at least one urging mechanism is a spring.

14. A method for manufacturing a battery pack, the method comprising the steps of:
providing a plurality of battery cells configured to generate an electrical current from an electrochemical reaction;
providing a battery tray including a channel configured to permit at least an axial translation of the battery cells in respect of a longitudinal axis of the battery tray; and
disposing the battery cells at least partially within the channel of the battery tray.

15. The method of claim 14, wherein the battery tray is a unitary structure to provide structural integrity to the battery pack.

16. The method of claim 14, further comprising the step of disposing a cooling element between adjacent battery cells.

17. The method of claim 16, wherein each of the cooling elements is in fluid communication with a supply fluid manifold and an exhaust fluid manifold through a flexible conduit.

18. The method of claim 14, further comprising the step of providing at least one urging mechanism to apply a compressive load to the battery cells in a first axial direction substantially parallel to the longitudinal axis of the battery tray.

19. The method of claim 18, wherein the at least one urging mechanism permits axial translation of the battery cells in respect of the longitudinal axis of the battery tray.

20. The method of claim 16, further comprising the step of disposing a spacer between the cooling element adjacent one battery cell and a main body of another adjacent battery cell.
